(19) United States
(12) Patent Application Publication
(10) Pub. No.: US 2025/0237880 A1
(43) Pub. Date: Jul. 24, 2025

(54) CONTROL DEVICE

(71) Applicant: CANON KABUSHIKI KAISHA, Tokyo (JP)

(72) Inventor: SHIMON UEMURA, Tokyo (JP)

(21) Appl. No.: 19/177,282

(22) Filed: Apr. 11, 2025

Related U.S. Application Data
(63) Continuation of application No. PCT/JP2023/027357, filed on Jul. 26, 2023.

(30) Foreign Application Priority Data
Oct. 17, 2022 (JP) 2022-166091

(51) Int. Cl. G02B 27/01

(52) U.S. Cl. CPC G02B 27/0179; G02B 27/0172; G02B 2027/014; G02B 2027/0178; G02B 2027/0187

(57) ABSTRACT

A control device according to the present invention is a control device configured to control an optical see-through type display apparatus, the control device including one or more processors and/or circuitry configured to execute acquisition processing of acquiring line-of-sight information of a user, a detection processing of detecting a real object that the user is viewing on a basis of the line-of-sight information, and a control processing of performing control to adjust an imaging distance of a virtual object according to a distance between the display apparatus and the detected real object.

### CROSS-REFERENCE TO RELATED APPLICATIONS

This application is a Continuation of International Patent Application No. PCT/JP2023/027357, filed Jul. 26, 2023, which claims the benefit of Japanese Patent Application No. 2022-166091, filed Oct. 17, 2022, all of which are hereby incorporated by reference herein in their entirety.

### BACKGROUND OF THE INVENTION

### Field of the Invention

The present invention relates to a control device that controls an optical see-through type head-mounted display apparatus.

### Background Art

With the spread of head-mounted display apparatuses, technologies for fusing a real world (real space) and a virtual world (virtual space), such as augmented reality (AR) and mixed reality (MR), have advanced.

PTL 1 discloses a head-up display apparatus that displays a virtual image in front of a driver and adjusts an imaging distance from the driver to the virtual image in accordance with a traveling state (for example, speed) of a vehicle. PTL 2 discloses a see-through type head-mounted display apparatus that sets an imaging distance of a projection image in the middle of a depth range of a work space.

However, in the related art, depending on the real object (real object) viewed by the user, the virtual object (virtual object such as the virtual image and the projection image described above) looks blurred greatly. For example, in the technique disclosed in PTL 1, a virtual image appears largely blurred depending on a distance from a driver to a real object gazed by the driver. In the technique disclosed in PTL 2, the observer can see the projection image with almost no blur when looking at the middle of the depth range of the work space. When the depth range is narrow, the observer can see the projection image with a small blur amount at any position in the depth range. However, when the depth range is wide (for example, in a case where the work space is outdoors), the projection image may appear largely blurred. For example, in a case where the frontmost real object is viewed and in a case where the rearmost real object is viewed, the projection image looks blurred greatly.

### CITATION LIST

### Patent Literature

PTL 1 JP 2020-37351 A
PTL 2 JP 2010-139575 A

### SUMMARY OF THE INVENTION

The present invention provides a technology capable of showing a virtual object to a user with a small blur amount even when the user looks at any real object.

The present invention in its first aspect provides a control device configured to control an optical see-through type display apparatus, the control device including one or more processors and/or circuitry configured to execute acquisition processing of acquiring line-of-sight information of a user, a detection processing of detecting a real object that the user is viewing on a basis of the line-of-sight information, and a control processing of performing control to adjust an imaging distance of a virtual object according to a distance between the display apparatus and the detected real object.

The present invention in its second aspect provides a control method for controlling an optical see-through type display apparatus, the control method including acquiring line-of-sight information of a user, detecting a real object that the user is viewing on a basis of the line-of-sight information, and performing control to adjust an imaging distance of a virtual object according to a distance between the display apparatus and the detected real object.

The present invention in its third aspect provides a non-transitory computer readable medium that stores a program, wherein the program causes a computer to execute a control method for controlling an optical see-through type display apparatus, the control method including acquiring line-of-sight information of a user, detecting a real object that the user is viewing on a basis of the line-of-sight information, and performing control to adjust an imaging distance of a virtual object according to a distance between the display apparatus and the detected real object.

Further features of the present invention will become apparent from the following description of exemplary embodiments with reference to the attached drawings.

### BRIEF DESCRIPTION OF THE DRAWINGS

FIGS. 1A and 1B are external views of a display apparatus, and FIG. 1C is a schematic view illustrating an optical system of the display apparatus.

FIG. 2 is a block diagram of the display apparatus.

FIG. 3 is a diagram describing a principle of a line-of-sight detection method.

FIG. 4A is a diagram illustrating an eye image, and FIG. 4B is a diagram illustrating a brightness distribution of the eye image.

FIG. 5 is a flowchart of line-of-sight detection processing.

FIG. 6 is a flowchart of overall processing according to a first embodiment.

FIG. 7 is a table illustrating a correspondence relationship between a distance and a lens drive amount.

FIGS. 8A and 8B are schematic diagrams illustrating appearance by a user.

FIG. 9 is a flowchart of overall processing according to a second embodiment.

FIG. 10 is a schematic diagram illustrating a real object and a virtual object.

FIG. 11 is a modification of the flowchart of overall processing according to the second embodiment.

### DESCRIPTION OF THE EMBODIMENTS

### First Embodiment

A first embodiment of the present invention is described. In the first embodiment, an example in which the present invention is applied to an optical see-through type head-mounted display apparatus (HMD, head-mounted display) will be described. The optical see-through type head-mounted display apparatus is, for example, a smart glass (augmented reality (AR) glass). The optical see-through type head-mounted display apparatus has, for example, a lens (optical member) similar to a lens of general eyeglasses, and projects a graphic (for example, a virtual object) onto the lens. A user wearing the optical see-through type head-mounted display apparatus can see the outside world (real space) or a graphic projected (displayed) by the head-mounted display apparatus through the optical member (lens). In the first embodiment, an example in which the present invention is applied to a head-mounted display apparatus in which a user views graphics with both eyes will be described, but the present invention is also applicable to a head-mounted display apparatus in which a user views graphics with one eye.

The present invention is applicable to a control apparatus that controls an optical see-through type head-mounted display apparatus, and the control apparatus may be provided in the head-mounted display apparatus or may be provided in an electronic device separate from the head-mounted display apparatus. For example, the present invention is also applicable to a controller or a personal computer (PC) connected to the optical see-through type head-mounted display apparatus.

### Description of Configuration

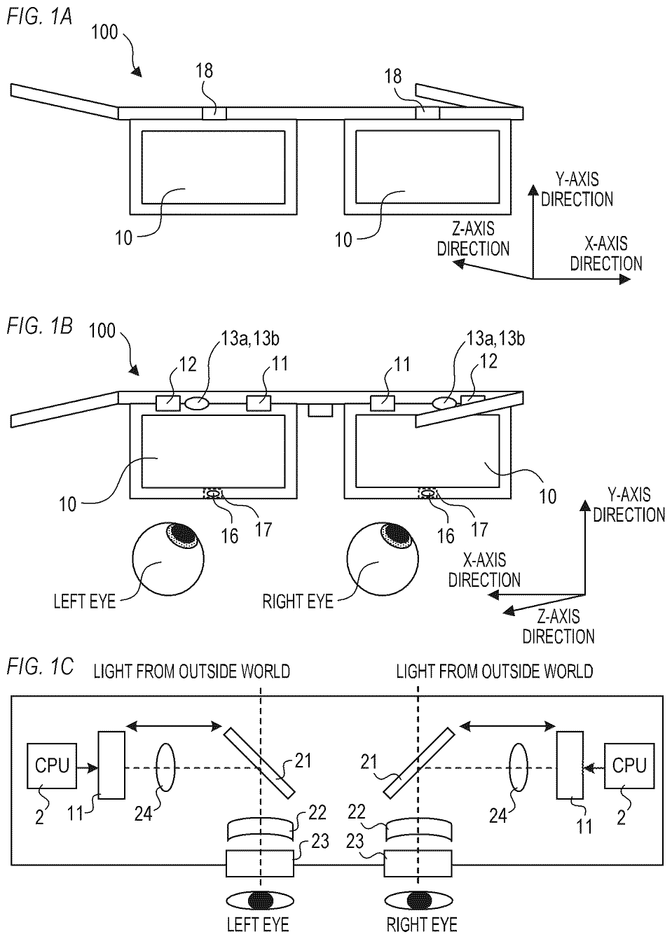

FIGS. 1A and 1B illustrate an appearance of a display apparatus 100 according to the first embodiment. FIG. 1A is a front perspective view, and FIG. 1B is a rear perspective view. The display apparatus 100 is an optical see-through type head-mounted display apparatus. The display apparatus 100 can individually detect a line of sight of the right eye and a line of sight of the left eye of a user wearing the display apparatus 100 on the head. Hereinafter, the user wearing the display apparatus 100 on the head is simply referred to as a user.

A lens unit 10 faces (faces) the eye (eye) of the user, and the user can visually recognize the outside world through the lens unit 10. A display device 11 displays graphics (for example, a virtual image of a virtual object) for both eyes (both right eye and left eye) of the user under control (display control) from a CPU 2 to be described later. For example, the display device 11 projects graphics onto the lens unit 10 through an optical system described later with reference to FIG. 1C. The display device 11 displays, for example, a graphical user interface (GUI, for example, buttons or icons) as a graphic. The user can view the displayed graphic (virtual object) as if it exists in the outside world. When the graphic is displayed, a depth position (position in the depth direction (direction away from the user)) of the graphic viewed from the user can be adjusted by adjusting a positional relationship (parallax) in the left-to-right direction between a display position with respect to the right eye and a display position with respect to the left eye.

A light source drive circuit 12 drives light sources 13a and 13b. Each of the light source 13a and the light source 13b is a light source that illuminates the eyes of the user, and is, for example, an infrared light-emitting diode that emits infrared light insensitive to the user. A part of the light emitted from the light sources 13a and 13b and reflected by the user's eye is condensed on an eye imaging element 17 by a light-receiving lens 16. The eye imaging element 17 is an imaging sensor (imaging element) that images the eye of the user. The imaging sensor is, for example, a charge coupled device (CCD) sensor or a complementary metal oxide semiconductor (CMOS) sensor.

The lens unit 10, the display device 11, the light source drive circuit 12, the light sources 13a and 13b, the light-receiving lens 16, and the eye imaging element 17 are provided for each of the right eye and the left eye. Line-of-sight information of the user can be acquired using the light source drive circuit 12, the light sources 13a and 13b, the light-receiving lens 16, and the eye imaging element 17. The line-of-sight information is information related to a line of sight, and indicates, for example, at least one of a viewpoint, a line-of-sight direction (a direction of a line of sight), and a convergence angle (an angle formed by a line of sight of the right eye and a line of sight of the left eye). The viewpoint can also be regarded as a position at which a line of sight is focused, a position at which the user is viewing, or a line-of-sight position. Details of a method of acquiring the line-of-sight information will be described later.

The external imaging element 18 is also provided for each of the right eye and the left eye. The external imaging element 18 is an imaging sensor (imaging element) that images an external scene in a direction in which the user faces. The imaging sensor is, for example, a CCD sensor or a CMOS sensor. For example, the external imaging element 18 is used to detect a real object viewed by the user. Various known techniques may be used to detect the real object. By using the two external imaging elements 18 (stereo cameras), it is also possible to detect (measure) the distance from the user (display apparatus 100) to the real object. Various known techniques may be used for distance measurement, and a sensor different from the two external imaging elements 18 (stereo cameras) may be used. For example, a light detection and ranging (LiDAR) sensor using laser light, or a time of flight (TOF) sensor using light-emitting diode (LED) light may be used. The distance may be measured by phase difference AF (AutoFocus) using one imaging sensor.

FIG. 1C is a schematic diagram illustrating an optical system of the display apparatus 100. The lens unit 10 includes an optical splitter 21, an eyepiece lens 22, and an eyepiece portion 23. The optical splitter 21 includes a half mirror or a prism, transmits light from the outside world toward the eyepiece lens 22, and reflects light from the display device 11 toward the eyepiece lens 22. Light from the outside world and light from the display device 11 enter the eye (right eye or left eye) of the user through the eyepiece lens 22 and the eyepiece portion 23. This allows the user to view both the outside world and graphics (virtual objects) displayed by the display device 11.

An adjustment lens 24 is provided between the display device 11 and the optical splitter 21. By adjusting the position of the adjustment lens 24 between the display device 11 and the optical splitter 21, the imaging distance of the graphic displayed by the display device 11 can be adjusted. This is a process of adjusting the depth position at which the graphic is in focus (the depth position at which the graphic can be viewed with substantially no blur), and is different from the process of adjusting the depth position of the graphic itself. For example, in the method for adjusting parallax described above, the depth position of the graphic itself is adjusted, and the stereoscopic effect of the graphic is adjusted, but the blur of the graphic is not adjusted. In the method of adjusting the imaging distance, the stereoscopic effect of the graphic is not adjusted, but the blur of the graphic is adjusted.

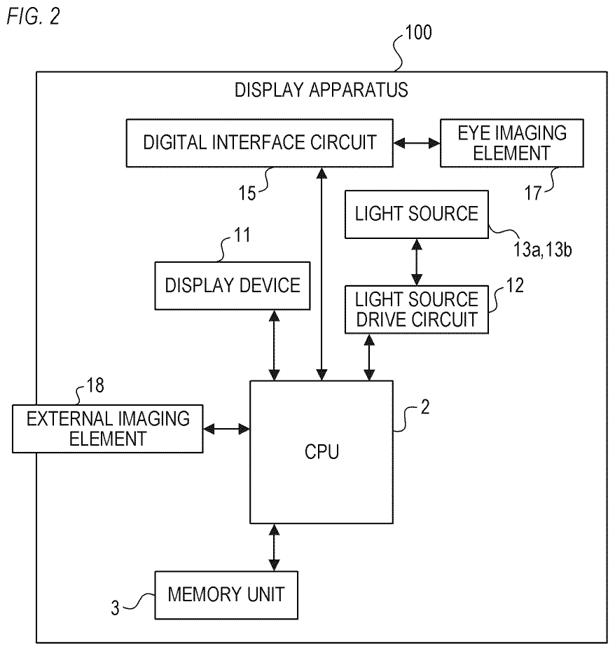

FIG. 2 is a block diagram illustrating an electrical configuration of the display apparatus 100. The CPU 2 is a central processing unit of a microcomputer incorporated in the display apparatus 100, and controls the display apparatus 100 overall. The display device 11, the light source drive circuit 12, a digital interface circuit 15, the external imaging element 18, and a memory unit 3 are connected to the CPU 2.

The memory unit 3 has a storage function of a video signal from the eye imaging element 17 and a storage function of a line-of-sight correction parameter (parameter for correcting an individual difference in a line of sight) to be described later.

The digital interface circuit 15 performs A/D conversion on the output of the eye imaging element 17 (eye image obtained by imaging the eye) in a state in which the optical image of the eye is formed on the eye imaging element 17, and transmits the result to the CPU 2. The CPU 2 extracts a characteristic point necessary for line-of-sight detection from the eye image according to a predetermined algorithm to be described later, and detects the line of sight of the user from the position of the characteristic point. The CPU 2 may display information (virtual object) related to the real object viewed by the user on the display device 11 according to the detection result of the GUI gaze.

### <Description of Line-of-Sight Detection Processing>

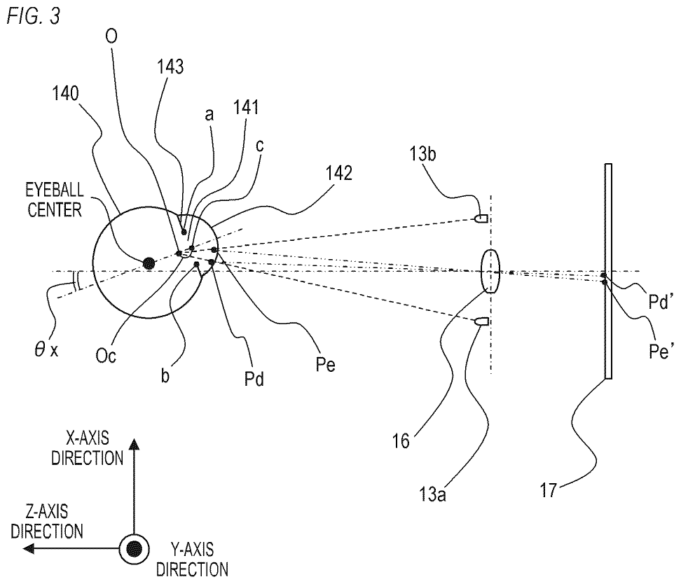

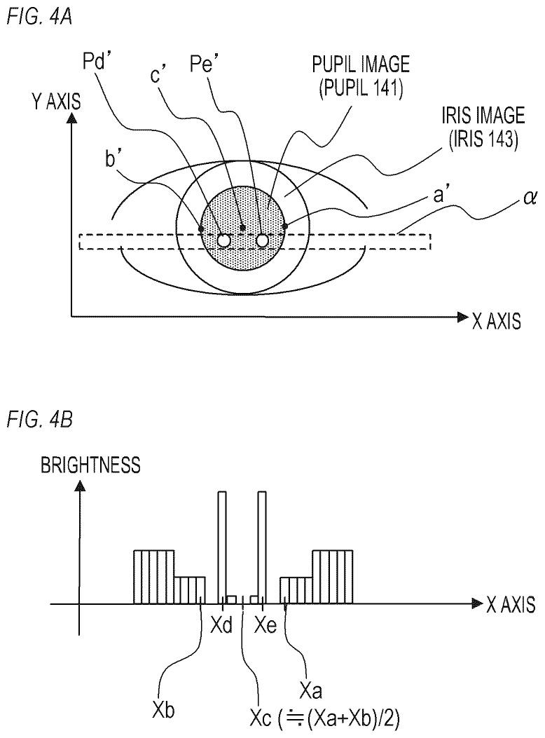

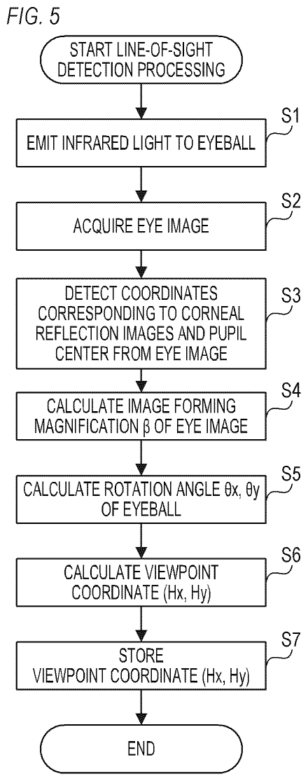

Line-of-sight detection processing (line-of-sight detection method) will be described with reference to FIGS. 3, 4A, 4B, and 5. Both the line of sight of the right eye and the line of sight of the left eye are detected by the following line-of-sight detection method. FIG. 3 is a diagram describing a principle of the line-of-sight detection method, and is a schematic diagram of an optical system for detecting a line of sight. As illustrated in FIG. 3, the light sources 13a and 13b are arranged substantially symmetrically with respect to the optical axis of the light-receiving lens 16, and illuminate an eyeball 140 of the user. A part of the light emitted from the light sources 13a and 13b and reflected by the eyeball 140 is condensed on the eye imaging element 17 by the light-receiving lens 16. FIG. 4A is a schematic diagram of an eye image (an optical image of an eye projected on the eye imaging element 17) captured by the eye imaging element 17, and FIG. 4B is a diagram illustrating output intensity of the eye imaging element 17. FIG. 5 is a flowchart of line-of-sight detection processing.

When the line-of-sight detection processing in FIG. 5 starts, in step S1, the CPU 2 drives the light sources 13a and 13b using the light source drive circuit 12 so as to emit infrared light toward the eyeball 140 of the user. An optical image of the user's eye illuminated by the infrared light is formed on the eye imaging element 17 through the light-receiving lens 16, and is photoelectrically converted by the eye imaging element 17. Thereby, an electrical signal of the processable eye image is obtained.

In step S2, the CPU 2 acquires an eye image (image data and image signal) from the eye imaging element 17 via the digital interface circuit 15.

In step S3, the CPU 2 detects coordinates of points corresponding to corneal reflection images Pd and Pe of the light sources 13a and 13b and a pupil center c from the eye image obtained in step S2.

The infrared light emitted from the light sources 13a and 13b illuminates a cornea 142 of the eyeball 140 of the user. At this time, the corneal reflection images Pd and Pe formed by a part of the infrared light reflected by the surface of the cornea 142 are condensed by the light-receiving lens 16 and are formed on the eye imaging element 17, thereby forming corneal reflection images Pd′ and Pe′ in the eye image. Similarly, light fluxes from ends a and b of a pupil 141 are also imaged on the eye imaging element 17, thereby forming pupil end images a′ and b′ in the eye image.

FIG. 4B illustrates brightness information (brightness distribution) of a region a in the eye image illustrated in FIG. 4A. FIG. 4B illustrates the brightness distribution in the X-axis direction with the horizontal direction of the eye image as the X-axis direction and the vertical direction as the Y-axis direction. In the first embodiment, coordinates of the corneal reflection images Pd′ and Pe′ in the X-axis direction (horizontal direction) are Xd and Xe, and coordinates of the pupil end images a′ and b′ in the X-axis direction are Xa and Xb. As illustrated in FIG. 4B, at the coordinates Xd and Xe of the corneal reflection images Pd′ and Pe′, brightness at an extremely high level is obtained. In a region from the coordinate Xa to the coordinate Xb, which corresponds to a region of the pupil 141 (a region of a pupil image obtained by forming the light flux from the pupil 141 on the eye imaging element 17), extremely low level brightness is obtained except for the coordinates Xd and Xe. Then, in a region of an iris 143 outside the pupil 141 (a region of an iris image outside a pupil image obtained by imaging the light flux from the iris 143), intermediate brightness between the above two types of brightness is obtained. For example, in a region where the X coordinate (coordinate in the X-axis direction) is larger than the coordinate Xa and a region where the X coordinate is smaller than the coordinate Xb, intermediate brightness between the two types of brightness is obtained.

The X coordinates Xd and Xe of the corneal reflection images Pd′ and Pe′ and the X coordinates Xa and Xb of the pupil end images a′ and b′ can be obtained from the brightness distribution as illustrated in FIG. 4B. For example, coordinates with extremely high brightness can be obtained as coordinates of the corneal reflection images Pd′ and Pe′, and coordinates with extremely low brightness can be obtained as coordinates of the pupil end images a′ and b′. When a rotation angle θx of the optical axis of the eyeball 140 with respect to the optical axis of the light-receiving lens 16 is small, coordinates Xc of a pupil center image c′(the center of the pupil image) obtained by imaging the light flux from the pupil center c on the eye imaging element 17 can be expressed as Xc≈(Xa+Xb)/2. That is, the coordinate Xc of the pupil center image c′ can be calculated from the X coordinates Xa and Xb of the pupil end images a′ and b′. In this manner, the coordinates of the corneal reflection images Pd′ and Pe′ and the coordinates of the pupil center image c′ can be estimated.

In step S4, the CPU 2 calculates an image forming magnification β of the eye image. The image forming magnification β is a magnification determined by the position of the eyeball 140 with respect to the light-receiving lens 16, and can be calculated using a function of an interval (Xd−Xe) between the corneal reflection images Pd′ and Pe′.

In step S5, the CPU 2 calculates the rotation angle of the optical axis of the eyeball 140 with respect to the optical axis of the light-receiving lens 16. An X coordinate of a midpoint between the corneal reflection image Pd and the corneal reflection image Pe substantially coincides with an X coordinate of a curvature center O of the cornea 142. Therefore, when a standard distance from the curvature center O of the cornea 142 to the center c of the pupil 141 is defined as Oc, the rotation angle θx of the eyeball 140 in the Z-X plane (plane perpendicular to the Y axis) can be calculated by the following Formula 1. A rotation angle θy of the eyeball 140 in the Z-Y plane (plane perpendicular to the X axis) can also be calculated by a method similar to the method of calculating the rotation angle θx.

$$β \times Oc \times SIN θ x \approx \{ ( Xd + Xe ) / 2 \} - Xc \qquad ( Formula 1 )$$

In step S6, the CPU 2 estimates the viewpoint of the user on the lens unit 10 using the rotation angles θx and Oy calculated in step S5. Assuming that coordinates (Hx, Hy) of the viewpoint are coordinates corresponding to the pupil center c, the coordinates (Hx, Hy) of the viewpoint can be calculated by the following Formulas 2 and 3.

$$Hx = m \times ( Ax \times θ x + Bx ) \qquad ( Formula 2 )$$

$$Hy = m \times ( Ay \times θ y + By ) \qquad ( Formula 3 )$$

A parameter m in Formulas 2 and 3 is a constant determined by a configuration of the optical system for performing the line-of-sight detection processing, and is a conversion coefficient for converting the rotation angles θx and Oy into coordinates corresponding to the pupil center c on the lens unit 10. It is assumed that the parameter m is determined in advance and is stored in the memory unit 3. Parameters Ax, Bx, Ay, and By are line-of-sight correction parameters for correcting individual differences in the line of sight, and are acquired by performing calibration of the line-of-sight detection. It is assumed that the line-of-sight correction parameters Ax, Bx, Ay, and By are stored in the memory unit 3 before the line-of-sight detection processing starts.

In step S7, the CPU 2 stores the coordinates (Hx, Hy) of the viewpoint in the memory unit 3, and ends the line-of-sight detection processing.

It is noted that the line-of-sight detection method is not limited to the above-described method, and for example, any method may be used as long as the method is a method of acquiring the line-of-sight information from the eye image. The line of sight may be detected by a method not using an eye image, such as a method of detecting an eye potential and detecting a line of sight on the basis of the eye potential, without using the eye image. As the final line-of-sight information, information indicating a line-of-sight direction (line-of-sight direction) may be obtained instead of information indicating a viewpoint. For example, processing up to obtaining the rotation angle (Ax×θx+Bx or Ay×θy+By) may be performed without obtaining the coordinates (Hx, Hy) of the viewpoint.

### Description of Overall Processing

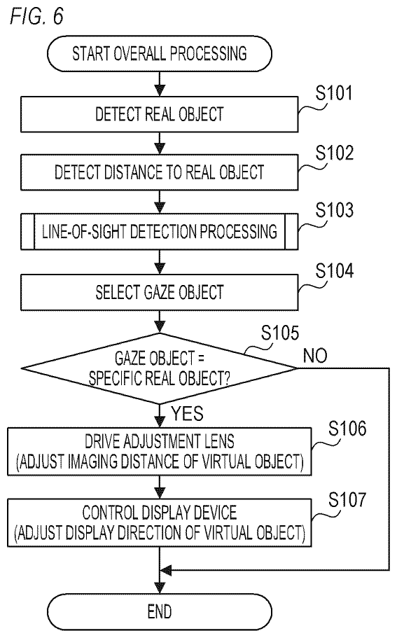

FIG. 6 is a flowchart of the overall processing according to a first embodiment. For example, when a user wears the display apparatus 100 and activates the display apparatus 100, overall processing in FIG. 6 is started. The CPU 2 repeats the overall processing of FIG. 6.

In step S101, the CPU 2 detects the real object from the image captured by the external imaging element 18 (the image of the outside world corresponding to the user's field of view (visual field)). For example, the CPU 2 detects a predetermined type of real object using a trained model (a training model trained by deep learning). Note that, as described above, the method of detecting the real object is not particularly limited, and various known techniques can be used. For example, the CPU 2 may detect the real object by performing template matching.

In step S102, the CPU 2 detects (measures) the distance from the user (display apparatus 100) to the real object detected in step S101 on the basis of the difference information between the two images captured by the two external imaging elements 18. Note that, as described above, the method of measuring the distance is not particularly limited, and various known techniques can be used.

In step S103, the CPU 2 acquires the line-of-sight information of the user by performing the line-of-sight detection processing of FIG. 5.

In step S104, the CPU 2 detects (selects) a real object (gaze object) viewed by the user from one or more real objects detected in step S101 on the basis of the line-of-sight information acquired in step S103. Note that, in a case where there are a plurality of real objects in the line-of-sight direction of the user, the CPU 2 may calculate the priority for each of the plurality of real objects. For example, the CPU 2 may calculate a higher priority as the frequency at which the viewpoint enters the area of the real object increases, or a higher priority as the time at which the viewpoint exists in the area of the real object increases. Then, the CPU 2 may detect (select) the real object having the highest priority as the gaze object.

In step S105, the CPU 2 determines whether the gaze object (the real object selected in step S104) is a specific real object. A specific real object will be described later. In a case where the CPU 2 determines that the gaze object is the specific real object, the processing proceeds to step S106, and in a case where the CPU 2 determines that the gaze object is not the specific real object, the overall processing of FIG. 6 ends. The determination method is not particularly limited, and various known techniques can be used. For example, the CPU 2 may determine whether the gaze object is a specific real object by using a trained model (a training model trained by deep learning). The CPU 2 may detect the real object by performing template matching. The CPU 2 may acquire information on the detected type of the real object when performing the process of step S101. Then, the CPU 2 may determine whether the gaze object is a specific real object according to the information acquired in step S101.

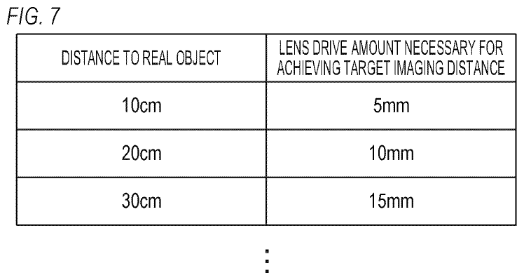

In step S106, the CPU 2 drives the adjustment lens 24 so that the virtual object can be displayed at the imaging distance corresponding to the distance (distance detected in step S102) from the user (display apparatus 100) to the gaze object. For example, the table illustrated in FIG. 7 is stored in the memory unit 3 in advance. The table of FIG. 7 illustrates a correspondence relationship between the distance from the user (display apparatus 100) to the real object and the drive amount (position adjustment amount) of the adjustment lens 24 necessary for achieving the imaging distance (target imaging distance) corresponding to the distance. The CPU 2 reads the drive amount corresponding to the distance from the user (display apparatus 100) to the gaze object from the table of FIG. 7, and drives the adjustment lens 24 with the read drive amount. Instead of the table, a function indicating a correspondence relationship between the distance to the real object and the drive amount of the adjustment lens 24 may be used. The target imaging distance is, for example, an imaging distance at which the user can see the virtual object with good visibility (with a small blur amount) while viewing the gaze object. The target imaging distance preferably substantially coincides with the distance from the user (display apparatus 100) to the gaze object.

In step S107, the CPU 2 controls the display device 11 to display the virtual object in a direction near the direction from the user (display apparatus 100) toward the gaze object. The virtual object is displayed in a direction near the direction from the user (display apparatus 100) toward the gaze object and at the imaging distance adjusted in step S106. The timing at which the virtual object is hidden is, for example, timing at which the user deviates the line of sight from the gaze object (the real object selected in step S104). The CPU 2 may hide the virtual object at a timing when a predetermined time (for example, 3 to 5 seconds) has elapsed in a state where the user does not see the real object selected in step S104.

It is assumed that there are a first real object and a second real object having different distances from the user (display apparatus 100). According to the overall processing of FIG. 6, the position of the adjustment lens 24 with respect to the display apparatus 100 is different between a case where the user is viewing the first real object and a case where the user is viewing the second real object.

### Description of Specific Real Object

The specific real object used for the determination in step S105 is, for example, a real object that is frequently viewed or touched by the user.

The specific real object may include a real object having a display unit (display surface) that displays various images or various types of information. The real object including the display unit is, for example, a personal computer (PC), a television device, a smartphone, a tablet terminal, or an operation panel of a machine tool installed in a factory.

The specific real object may include a real object including an operation unit operable by a user. The real object including the operation unit is, for example, a lighting switch in a room, a keyboard for a PC, or a switch of a machine tool installed in a factory.

### Description of Virtual Object

The virtual object displayed in step S107 is based on, for example, information on a real object that the user is viewing. A display method (generation method) of the virtual object will be described later. For example, when the user operates an operation panel or a switch of the machine tool, a manual of an operation method or a screen indicating an operation status of the machine tool may be displayed as the virtual object. When the user confirms a failure of a machine tool (factory line), a design diagram (wiring diagram) may be displayed as a virtual object. When a user views video content on a television device, a PC, a smartphone, or a tablet terminal, a program guide may be displayed as a virtual object. An introduction screen of recommended video content (for example, popular video content or video content related to video content being viewed) may be displayed as a virtual object. When the user operates the PC, the smartphone, or the tablet terminal (for example, when working or using a site or application for communication), a mail screen may be displayed as a virtual object. An address book or a schedule screen may be displayed as a virtual object. In a case where the user needs to confirm a plurality of documents at work, a part of the plurality of documents may be displayed on the display unit, and the remaining documents may be displayed as virtual objects.

### Description of Virtual Object Display Method (Generation Method)

For example, the CPU 2 acquires information regarding a specific real object that the user is viewing, and displays a virtual object based on the acquired information on the display device 11. For a plurality of real objects, information related to the real object may be stored in advance in the memory unit 3, and the CPU 2 may acquire information related to a specific real object that the user is viewing from the memory unit 3. The display apparatus 100 may have a communication function (communication interface) of communicating with an external device. When the user is viewing a specific external device (for example, a PC, a television device, a smartphone, a tablet terminal, or an operation panel) having a communication function, the CPU 2 may acquire information related to the external device by communicating with the external device. The communication may be single-direction communication or bidirectional communication.

In the case of single-direction communication, for example, an external device periodically transmits information regarding itself. The CPU 2 generates a virtual object on the basis of information received from a specific external device that the user is viewing, and displays the virtual object on the display device 11. When receiving information from a plurality of external devices, the CPU 2 selects information related to a specific external device that the user is viewing from the plurality of pieces of information, and generates a virtual object on the basis of the selected information.

In the case of bidirectional communication, for example, the CPU 2 requests a specific external device that the user is viewing to transmit information. The external device that has received the request transmits information related to the external device to the display apparatus 100. Then, the CPU 2 generates a virtual object on the basis of information received from a specific external device that the user is viewing, and displays the virtual object on the display device 11.

The information transmitted from the specific external device that the user is viewing may or may not be information indicated by the displayed virtual object (for example, image data of the virtual object). For example, the information transmitted from the specific external device that the user is viewing may be information indicating a display screen of the external device. In this case, the CPU 2 determines information to be displayed on the basis of information received from a specific external device that the user is viewing, and generates a virtual object indicating the determined information. When generating the virtual object, the CPU 2 may acquire necessary information (information to be displayed) from the server. As described above, for example, a manual, a screen indicating an operation status of a machine tool, a plan, a mail screen, an address book, a schedule screen, or a document is displayed as a virtual object.

### Description of Control in Consideration of Environment

The display apparatus 100 may have an environment detection function of detecting an environment around the user (display apparatus 100). For example, the CPU 2 may detect the environment (scene) around the user on the basis of the image captured by the external imaging element 18. Then, the CPU 2 may determine (change) the specific real object to be used for the determination in step S105 according to the surrounding environment (detected environment) of the user. For example, in a case where it is determined that the user is in the office, the CPU 2 determines the real object having the display unit as the specific real object, and in a case where it is determined that the user is in the factory, the CPU 2 determines the real object having the operation unit as the specific real object.

### SUMMARY

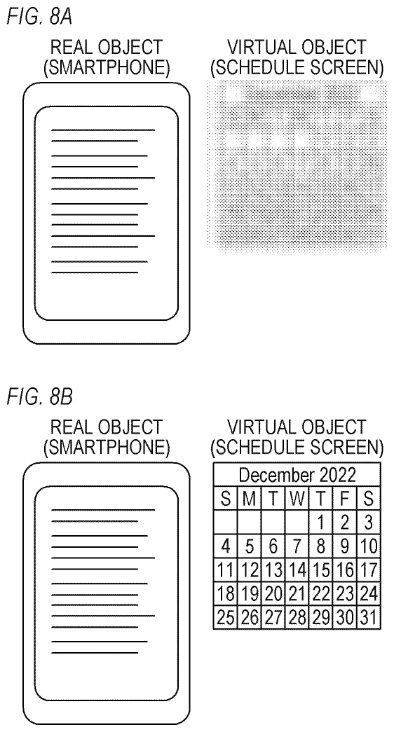

As described above, according to the first embodiment, the display direction and the imaging distance of the virtual object are adjusted based on the position of the real object viewed by the user. As a result, a virtual object can be shown to a user with a small blur amount even when the user looks at any real object. Even if a virtual object is displayed in a direction near the direction in which the real object viewed by the user exists, the virtual object looks blurred greatly when the imaging distance of the virtual object is greatly deviated from the distance to the real object. Therefore, when the imaging distance of the virtual object is constant (fixed) without performing the overall processing of FIG. 6, the virtual object may appear to be largely blurred as illustrated in FIG. 8A. When the overall processing of FIG. 6 is performed, the imaging distance of the virtual object is adjusted to the imaging distance corresponding to the real object viewed by the user, so that the virtual object can be shown to the user with a small blur amount as illustrated in FIG. 8B. FIGS. 8A and 8B are schematic diagrams illustrating appearance by a user.

Note that, although the example of adjusting the imaging distance of the virtual object has been described, the parallax of the virtual object (the positional relationship in the left-to-right direction between the display position with respect to the right eye and the display position with respect to the left eye) may be further adjusted. For example, the CPU 2 may adjust the parallax of the virtual object such that the depth position of the virtual object substantially coincides the depth position of the real object that the user is viewing. In this way, a focused virtual object can be seen at a three-dimensional position near the real object that the user is viewing, and it is possible to achieve a non-uncomfortable appearance.

### Second Embodiment

A second embodiment of the present invention is described. Hereinafter, the description of the same points as those of the first embodiment (for example, the same configuration and processing as those of the first embodiment) will be omitted, and points different from those of the first embodiment will be described. In the first embodiment, the virtual object is displayed in response to the user viewing the specific real object, but in the second embodiment, one or more virtual objects are displayed in advance.

### Description of Overall Processing

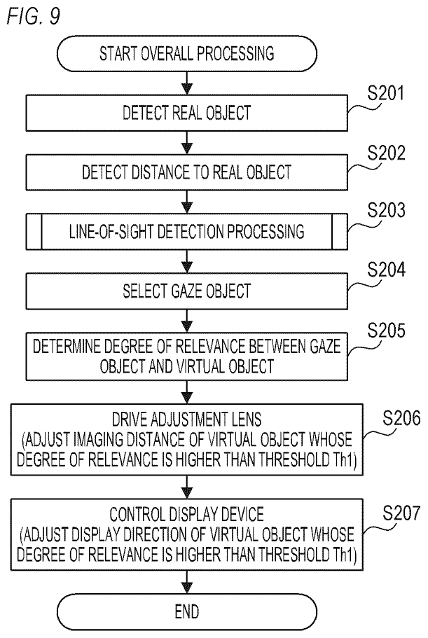

FIG. 9 is a flowchart of overall processing according to the second embodiment. For example, when a user wears the display apparatus 100 and activates the display apparatus 100, the overall processing of FIG. 9 is started. The CPU 2 performs repetition on the overall processing of FIG. 9. The CPU 2 displays a plurality of virtual objects on the display device 11 before starting the overall processing of FIG. 9.

Steps S201 to S204 are the same as steps S101 to S104 of the first embodiment (FIG. 3).

In step S205, the CPU 2 determines a degree of relevance between each of the plurality of displayed virtual objects and the gaze object (the real object selected in step S204 and viewed by the user). A method for determining the degree of relevance will be described later.

In step S206, the CPU 2 selects, from the plurality of displayed virtual objects, a virtual object whose degree of relevance determined in step S205 is higher than a threshold Th1. Then, the CPU 2 drives the adjustment lens 24 so as to change the imaging distance of the selected virtual object to an imaging distance corresponding to the distance from the user (display apparatus 100) to the gaze object (the distance detected in step S202).

In step S207, the CPU 2 controls the display device 11 so as to change the display direction of the virtual object selected in step S206 to a direction near the direction from the user toward the gaze object. The virtual object whose degree of relevance is higher than the threshold Th1 is displayed in a direction near the direction from the user toward the gaze object and at the imaging distance adjusted in step S206.

### Method for Determining Degree of Relevance

Before starting the overall processing of FIG. 9, the CPU 2 may display a virtual object corresponding to the information displayed on the display unit of the real object (for example, a PC, a television device, a smartphone, a tablet terminal, or an operation panel) on the display device 11. For example, when the real object displays a plurality of pieces of information on the display unit, the CPU 2 may display a plurality of virtual objects corresponding to the plurality of pieces of information on the display device 11. Then, the CPU 2 may set a degree of relevance higher than the threshold Th1 as the degree of relevance of the virtual object corresponding to the information that the user is viewing (information displayed on the display unit). The CPU 2 may set a degree of relevance lower than the threshold Th1 as the degree of relevance of the remaining virtual objects.

Before starting the overall processing of FIG. 9, the CPU 2 may display a plurality of virtual objects respectively corresponding to a plurality of real objects on the display device 11. Then, the CPU 2 may set a degree of relevance higher than the threshold Th1 as the degree of relevance of the virtual object corresponding to the real object that the user is viewing. The CPU 2 may set a degree of relevance lower than the threshold Th1 as the degree of relevance of the remaining virtual objects. The real object and the virtual object may not be in a one-to-one correspondence. A plurality of virtual objects may be associated with one real object. For example, a plurality of virtual objects corresponding to a plurality of pieces of information displayed on the display unit of the real object may be treated as virtual objects corresponding to the real object.

For each of the plurality of virtual objects, a default imaging distance (an imaging distance before starting the overall processing of FIG. 9) may be predetermined. For example, the imaging distance corresponding to the distance from the user (display apparatus 100) to the real object may be predetermined as the default imaging distance of the virtual object corresponding to the real object. Then, the CPU 2 may determine a higher value as the default imaging distance of the virtual object is closer to the distance from the user to the real object that the user is viewing as the degree of relevance of the virtual object.

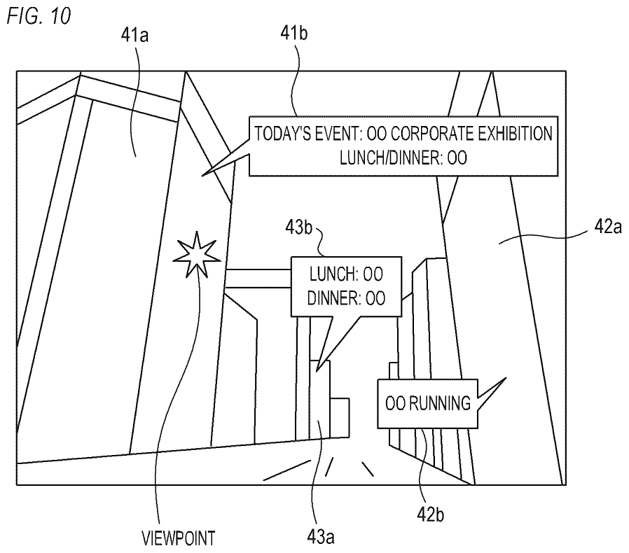

For example, as illustrated in FIG. 10, in a case where the user is viewing a department store 41a, a degree of relevance higher than the threshold Th1 is set for a virtual object 41b corresponding to the department store 41a. The content of the virtual object 42b corresponding to a movie theater 42a is not similar to the content of the virtual object 41b, but since the movie theater 42a is close to the department store 41a, there is a high possibility that the virtual object 42b is useful for the user. Therefore, the degree of relevance higher than the threshold Th1 is also set for the virtual object 42b. Then, the content of the virtual object 43b corresponding to a restaurant 43a is similar to the content of the virtual object 41b, but since the restaurant 43a is far away from the department store 41a, there is a low possibility that the virtual object 43b is useful for the user. Therefore, the degree of relevance lower than the threshold Th1 is also set for the virtual object 43b.

The CPU 2 may detect a virtual object in which the user repeatedly moves the line of sight from the real object on the basis of the line-of-sight information, and set a degree of relevance higher than the threshold Th1 for the virtual object. The CPU 2 may set a degree of relevance lower than the threshold Th1 as the degree of relevance of the remaining virtual objects.

As described above, according to the second embodiment, the display direction and the imaging distance of the virtual object whose degree of relevance to the real object that the user is viewing is higher than the threshold Th1 are adjusted. As a result, a virtual object (information) useful for the user can be shown to the user with a small blur amount.

Note that an example in which a plurality of virtual objects is displayed before the overall processing of FIG. 9 is started has been described, but the present invention is not limited thereto. At the start of the overall processing of FIG. 9, it is sufficient that there is a plurality of virtual objects that can be displayed, and the plurality of virtual objects may not be displayed.

In addition, the CPU 2 may display, on the display device 11, a virtual object whose degree of relevance is lower than the threshold Th2 with reduced saliency. By doing so, it is possible to suppress the user from being distracted by virtual objects (information) that are not useful for the user. The threshold Th2 (threshold as to whether the degree of relevance is low) may be equal to or less than the threshold Th1 (equal to or less than the threshold as to whether the degree of relevance is high), and may be equal to the threshold Th1. Saliency may be regarded as a degree of prominence or visibility.

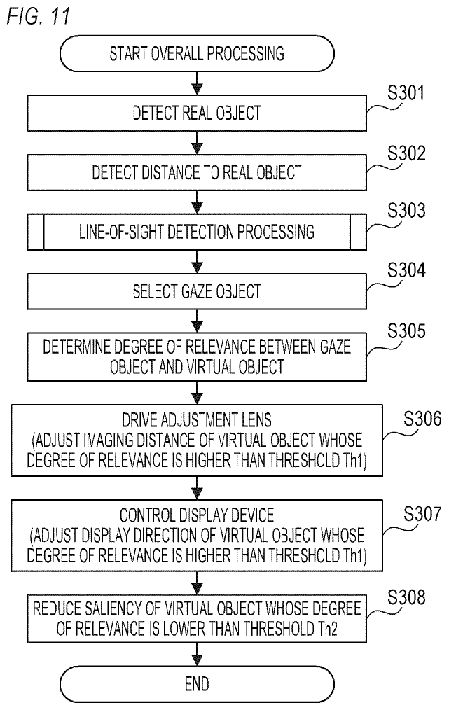

The CPU 2 may perform the overall processing of FIG. 11. For example, when a user wears the display apparatus 100 and activates the display apparatus 100, the overall processing of FIG. 11 is started. The CPU 2 performs repetition on the overall processing of FIG. 11. The CPU 2 displays a plurality of virtual objects on the display device 11 before starting the overall processing of FIG. 11.

Steps S301 to S307 are the same as steps S201 to S207 in FIG. 9. In step S308, the CPU 2 performs image processing of reducing saliency on the virtual object whose degree of relevance is lower than a threshold Th2. The image processing is not particularly limited, and is, for example, processing of blurring a virtual object, processing of increasing transmittance of a virtual object, processing of coloring a virtual object, or processing of reducing a virtual object. The CPU 2 may hide a virtual object whose degree of relevance is lower than the threshold Th2.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present invention are also included in the present invention. The present invention also includes other configurations obtained by suitably combining various features of the embodiment.

According to the present invention, a virtual object can be shown to a user with a small blur amount even when the user looks at any real object.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A control device configured to control an optical see-through type display apparatus, the control device comprising
one or more processors and memory configured to:
execute acquisition processing of acquiring line-of-sight information of a user;
a detection processing of detecting a real object that the user is viewing on a basis of the line-of-sight information; and
a control processing of performing control to adjust an imaging distance of a virtual object according to a distance between the display apparatus and the detected real object.

2. The control device according to claim 1, wherein
in the control processing, control is performed to adjust the imaging distance to a distance substantially coinciding with a distance from the display apparatus to the detected real object.

3. The control device according to claim 1, wherein
in the control processing, control is performed to adjust the imaging distance in a case where the detected real object is a specific real object.

4. The control device according to claim 3, wherein
the specific real object includes a real object having a display or an operation member.

5. The control device according to claim 3, wherein
the one or more processors and memory further executes second acquisition processing of acquiring information on the specific real object, and
in the control processing, the display apparatus is controlled to display a virtual object based on the information acquired by the second acquisition processing.

6. The control device according to claim 5, wherein
the specific real object includes a specific external device having a communication function, and
in the second acquisition processing, the information is acquired by performing bidirectional communication with the detected real object in a case where the detected real object is the specific external device.

7. The control device according to claim 1, wherein
the one or more processors and memory further executes environment detection processing of detecting an environment around the user, wherein
in the control processing, the virtual object is determined according to the environment detected by the environment detection processing.

8. The control device according to claim 1, wherein
in the control processing, control is performed to adjust an imaging distance such that a blur amount of the virtual object becomes smaller than a predetermined value when the user is viewing the real object.

9. The control device according to claim 1, wherein
the one or more processors and memory further executes display control processing of performing control to change a display position of the virtual object according to the line-of-sight information.

10. The control device according to claim 1, wherein
the one or more processors and memory further executes:
determination processing of determining a degree of relevance between each of a plurality of displayable virtual objects and the real object detected by the detection processing; and
display control processing of performing control so as to display a virtual object whose degree of relevance is higher than a threshold.

11. The control device according to claim 10, wherein
in the display control processing, control is performed to display the plurality of virtual objects, and
in the control processing, control is performed to adjust an imaging distance of a virtual object whose degree of relevance is higher than the threshold according to a distance between the display apparatus and the detected real object.

12. The control device according to claim 10, wherein
a default imaging distance is predetermined for each of the plurality of virtual objects, and
in the determination processing, a higher value as a default imaging distance of the virtual object is closer to a distance from the display apparatus to the detected real object is determined as the degree of relevance of the virtual object.

13. The control device according to claim 10, wherein
in the control processing, control is performed to adjust an imaging distance of a virtual object such that the virtual object whose degree of relevance is lower than a second threshold equal to or less than the threshold is displayed with reduced saliency.

14. The control device according to claim 13, wherein
in the display control processing, a virtual object whose degree of relevance is lower than the second threshold is hidden.

15. The control device according to claim 10, wherein
in the control processing, control is performed to display the plurality of virtual objects,
the one or more processors and memory further executes second detection processing of detecting a virtual object to which the user repeatedly moves the line of sight from the detected real object on a basis of the line-of-sight information, and
in the control processing, control is performed to adjust an imaging distance of a virtual object detected by the second detection processing according to a distance between the display apparatus and the detected real object.

16. The control device according to claim 1, wherein
the display apparatus includes an adjustment lens for adjusting the imaging distance,
in the control processing, control is performed to change the imaging distance by changing a position of the adjustment lens in the display apparatus, and
a position of the adjustment lens in the display apparatus is different between a case where the user is viewing a first real object and a case where the user is viewing a second real object.

17. A control method for controlling an optical see-through type display apparatus, the control method comprising:
acquiring line-of-sight information of a user;
detecting a real object that the user is viewing on a basis of the line-of-sight information; and
performing control to adjust an imaging distance of a virtual object according to a distance between the display apparatus and the detected real object.

18. A non-transitory computer readable medium that stores a program, wherein the program causes a computer to execute a control method for controlling an optical see-through type display apparatus, the control method comprising:
acquiring line-of-sight information of a user;
detecting a real object that the user is viewing on a basis of the line-of-sight information; and
performing control to adjust an imaging distance of a virtual object according to a distance between the display apparatus and the detected real object.
